(19) United States
(12) Patent Application Publication
(10) Pub. No.: US 2010/0134524 A1
(43) Pub. Date: Jun. 3, 2010

(54) DISPLAY DEVICE

(75) Inventors: Keiji Hayashi, Osaka (JP); Kentaro Kamada, Osaka (JP)

Correspondence Address: HARNESS, DICKEY & PIERCE, P.L.C., P.O. BOX 8910, RESTON, VA, 20195, US

(73) Assignee: SHARP KABUSHIKI KAISHA, Osaka-shi, Osaka (JP)

(21) Appl. No.: 12/451,628

(22) PCT Filed: May 22, 2008
(86) PCT No.: PCT/JP2008/059415

§ 371 Date: Nov. 23, 2009

(30) Foreign Application Priority Data
May 25, 2007 (JP) 2007-139171

(51) Int. Cl. G06F 3/038; G09G 5/10

(52) U.S. Cl. 345/690; 345/213

(57) ABSTRACT

In one embodiment of the present invention, a display device is disclosed that can realize a wide color reproduction region and high color purity while maintaining a configuration of a display element having a high resolution and a high numerical aperture. The display device includes: an illumination device including a first light source that emits light of a first color and a second light source that emits light of a complementary color with respect to the first color; a gate driver that successively selects each of the scanning lines at a cycle of 0.5 frame; a data driver that writes a data signal into pixels of the first color and into at least one of pixels of a second color and a third color at a first half of one frame time period and writes a data signal into the pixels of the second color and the third color at a latter half thereof; and a switch circuit that switches on the first light source and switches off the second light source at the first half of one frame time period and switches on the second light source and switches off the first light source at the latter half of the time period.

### TECHNICAL FIELD

The present invention relates to a display device that includes a display element provided with color filters and an illumination device emitting plane-shaped light toward the display element. Particularly, the present invention relates to a display device capable of performing a multicolor display with more colors than those of the color filters.

### BACKGROUND ART

As a display device for a television receiver or the like, liquid crystal display devices characterized by, for example, being reduced in power consumption, thickness and weight have found widespread use. A liquid crystal display element itself does not emit light and thus is a so-called non-light-emitting type display element. Therefore, in a liquid crystal display device, for example, a plane light-emitting type illumination device (so-called backlight) is provided on one principal surface of the liquid crystal display element, and color filters of three colors of RGB provided at each pixel of the liquid crystal display elements transmit the light emitted from the backlight, whereby a color display can be performed.

As a light source for a backlight of the above-described conventional liquid crystal display device that performs such a color display, a cold cathode fluorescent tube called a three-band tube or a four-band tube is used. The three-band tube is a fluorescent tube having wavelengths of red (R), green (G), and blue (B), and the four-band tube is a fluorescent tube having wavelengths of red, green, blue, and deep red. In the case of the three-band tube, red, green, and blue phosphors are sealed in the tube. In the case of the four-band tube, red, green, blue, and deep red phosphors are sealed in the tube. In either of these cases, at the time of lighting, mixing of light of the respective wavelengths occurs, so that the liquid crystal display element is irradiated with the light (white light) having an emission spectrum in all wavelength regions.

Further, in the case where a light emitting diode (LED: Light Emitting Diode) is used as a light source for a backlight, a prism sheet, a diffusing plate or the like is used to mix the respective colors of light outputted from a red LED, a green LED, and a blue LED (a white LED further may be used) so as to form uniform white light, with which the liquid crystal display element then is irradiated.

On the other hand, in accordance with the spread of image display devices utilizing new display elements such as liquid crystal display devices, a new standard for the extended color space for video applications, i.e., xvYCC, has been proposed. As compared with the present color reproduction standard, i.e., sRGB, which has been defined based on the color reproduction range in a CRT, this xvYCC standard is intended to realize a wider color reproduction range, and therefore is capturing attentions as a next-generation standard for a more vivid and stereoscopic image display and a faithful color reproduction of movie contents shot on films

In order to correspond to this xvYCC standard, it is essential to extend the color reproduction range of the liquid crystal display device. However, even though the color purity of color filters of three colors of RGB formed on pixels of the liquid crystal display element is improved using a white light source in the above-described conventional backlight, a sufficient color reproduction range cannot be obtained.

As a specific method for extending the color reproduction range in the liquid crystal display element, a method has generally been adopted in which other than the three colors of RGB, color filters of other colors such as cyan (C), magenta (M) and yellow (Y), which are complementary to the three primary colors of RGB, respectively, or such as white are formed so as to perform a multicolor image display having 4 or more colors. For example, Patent Document 1 proposes a configuration in which a pixel portion is composed of 4 colors arrayed in 2 lines and 2 columns, with the color filters in the pixel portion being arrayed in “RGBC” and “RGBY”. The filter array in this conventional liquid crystal display element is shown in FIG. 20.

### [Patent Document 1] JP 2006-145982 A

### DISCLOSURE OF INVENTION

### Problem to be Solved by the Invention

However, in the above-described conventional configuration, since each of the pixel portions is composed of two lines, the number of required scanning lines is twice the number of scanning lines in the conventional liquid crystal display element in which three colors of RGB are arrayed in a scanning line direction. In this case, since a cycle for selecting a scanning line becomes shorter, a time in which one scanning line is selected becomes shorter, and consequently, a time for writing data signals for image display into pixels becomes insufficient.

Further, as a method applied to the pixel portions composed of two lines without the number of scanning lines increased, a so-called center gate method in which one scanning line is disposed between two pixel lines has been proposed. However, in this method, it is required that data signals for image display should simultaneously be written into the pixel composed of two lines selected by one scanning line, whereby twice the number of data lines are required.

Further, constituting one portion to perform image display with pixels for which filters of plural colors are formed is a cause that makes it difficult to realize high resolution. Furthermore, if the number of the scanning lines or gate lines is increased, in a region where each pixel of the liquid crystal display element is formed, the area used for arranging these electrodes increases. As a result, a numerical aperture in each pixel decreases, whereby problems such as a decrease in the brightness of the display element have arisen.

With the foregoing in mind, it is an object of the present invention to provide a display device that can realize a wide color reproduction region and high color purity while maintaining a configuration of a display element capable of realizing a high resolution and keeping a high numerical aperture.

### Means for Solving Problem

In order to achieve the above-described object, a display device according to the present invention includes: a display element that includes: scanning lines and data lines that are arranged in a matrix form; a switching element that is connected to each of the scanning lines and a corresponding one of the data lines; a pixel portion that performs a gradation display in accordance with a data signal written from the corresponding one of the data lines when the switching element is brought to an ON state based on a signal of the each of the scanning lines; and color filters that are arranged so as to correspond to the pixel portions and include three colors composed of a first color, a second color, and a third color that exhibit a white color when mixed; an illumination device that outputs plane-shaped light to the display element and includes a first light source that emits light of the first color and a second light source that emits light of a color complementary to the first color; a scanning line driving portion that sequentially supplies a selection signal to each of the scanning lines at a cycle of half a time period in which one frame is displayed in the display element; a data line driving portion that, at one of a first half and a latter half of the time period in which one frame is displayed in the display element, supplies data signals to the data lines in such a manner that a data signal to be written into a group of pixel portions among the pixel portions that corresponds to the color filter of the first color and a data signal to be written into at least either one of a group of pixel portions among the pixel portions that corresponds to the color filter of the second color and a group of pixel portions among the pixel portions that corresponds to the color filter of the third color is supplied to corresponding one of the data lines, and at an other of the first half and the latter half of the time period, a data signal to be written into the group of pixel portions among the pixel portions that corresponds to the color filter of the second color and the group of pixel portions among the pixel portions that corresponds to the color filter of the third color is supplied to corresponding one of data lines; and a light source driving portion that, at the one of the first half and the latter half of the time period in which one frame is displayed in the display element, switches on the first light source while switching off the second light source, and at the other of the first half and the latter half of the time period, switches on the second light source while switching off the first light source.

### EFFECTS OF THE INVENTION

With the present invention, it is possible to provide a display device that can realize a wide color reproduction region and high color purity while maintaining a configuration of a display element capable of realizing a high resolution and keeping a high numerical aperture.

### BRIEF DESCRIPTION OF DRAWINGS

FIG. 1 is a cross-sectional view schematically showing a configuration of a liquid crystal display device according to one embodiment of the present invention.

FIG. 2 is a block diagram showing a functional configuration of the liquid crystal display device according to Embodiment 1 of the present invention.

FIG. 3 is a timing chart showing one example of a relationship among timing for switching on/off light sources, timing for supplying a data signal to each of data lines, and amounts of light emitted by light sources in the liquid crystal display device according to Embodiment 1 of the present invention.

FIG. 4 is an image view showing the extension of the color reproduction range in the present invention.

FIG. 5 is a view showing spectrum distribution of the light sources in Example 1 of the liquid crystal display device according to Embodiment 1 of the present invention.

FIG. 6 is a chromaticity diagram showing a color reproduction range in Example 1 of the liquid crystal display device according to Embodiment 1 of the present invention in comparison with color reproduction ranges of Comparative Example 1 and conventional examples.

FIG. 7 is a view showing the spectrum distribution of light sources in Example 2 of the liquid crystal display device according to Embodiment 1 of the present invention.

FIG. 8 is a chromaticity diagram showing a color reproduction range in Example 2 of the liquid crystal display device according to Embodiment 1 of the present invention in comparison with color reproduction ranges of Comparative Example 2 and conventional examples.

FIG. 9 is a timing chart showing one example of a relationship among timing for switching on/off light sources, timing for supplying a data signal to each of data lines, and amounts of light emitted by the light sources in Comparative Examples 1 and 2 of the liquid crystal display device according to Embodiment 1 of the present invention.

FIG. 10 is a spectrum diagram showing an emission spectrum of a conventional three-band tube.

FIG. 11 is a block diagram showing a functional configuration of a liquid crystal display device according to Embodiment 2 of the present invention.

FIG. 12 is a timing chart showing one example of timing for switching on each cold cathode fluorescent tube in the liquid crystal display device according to Embodiment 2 of the present invention.

FIG. 13 is a timing chart showing another example of the timing for switching on each cold cathode fluorescent tube in the liquid crystal display device according to Embodiment 2 of the present invention.

FIG. 14 is a timing chart showing still another example of the timing for switching on each cold cathode fluorescent tube in the liquid crystal display device according to Embodiment 2 of the present invention.

FIG. 15 is a block diagram showing a functional configuration of a liquid crystal display device according to Embodiment 3 of the present invention.

FIG. 16 is a block diagram showing an internal configuration and a status of a signal process of an interpolation data generating portion provided in the liquid crystal display device according to Embodiment 3.

FIG. 17 is a block diagram showing a status of the signal process in another interpolation data generating method performed in the interpolation data generating portion provided in the liquid crystal display device according to Embodiment 3.

FIG. 18 is a plan view showing one example of an arrangement of LEDs used as light sources for a backlight in a liquid crystal display device as a modification example of Embodiments 1 to 3 of the present invention.

FIG. 19 is a timing chart showing one example of a relationship among timing for switching on/off light sources, timing for supplying a data signal to each of data lines, and amounts of light emitted by the light sources in the case where a first color is blue.

FIG. 20 is a view showing an arrangement of filters of the liquid crystal display device that performs a conventional multicolor display.

### DESCRIPTION OF PREFERRED EMBODIMENTS

The display device according to the present invention includes: a display element that includes: scanning lines and data lines that are arranged in a matrix form; a switching element that is connected to each of the scanning lines and a corresponding one of the data lines; a pixel portion that performs a gradation display in accordance with a data signal written from the corresponding one of the data lines when the switching element is brought to an ON state based on a signal of the each of the scanning lines; and color filters that are arranged so as to correspond to the pixel portions and include three colors composed of a first color, a second color, and a third color that exhibit a white color when mixed; an illumination device that outputs plane-shaped light to the display element and includes a first light source that emits light of the first color and a second light source that emits light of a color complementary to the first color; a scanning line driving portion that sequentially supplies a selection signal to each of the scanning lines at a cycle of half a time period in which one frame is displayed in the display element; a data line driving portion that, at one of a first half and a latter half of the time period in which one frame is displayed in the display element, supplies data signals to the data lines in such a manner that a data signal to be written into a group of pixel portions among the pixel portions that corresponds to the color filter of the first color and a data signal to be written into at least either one of a group of pixel portions among the pixel portions that corresponds to the color filter of the second color and a group of pixel portions among the pixel portions that corresponds to the color filter of the third color should be supplied to corresponding one of the data lines, and at an other of the first half and the latter half of the time period, a data signal to be written into the group of pixel portions among the pixel portions that corresponds to the color filter of the second color and the group of pixel portions among the pixel portions that corresponds to the color filter of the third color should be supplied to corresponding one of data lines; and a light source driving portion that, at the one of the first half and the latter half of the time period in which one frame is displayed in the display element, switches on the first light source while switching off the second light source, and at the other of the first half and the latter half of the time period, switches on the second light source while switching off the first light source.

Herein, “ . . . exhibit a white color when mixed” refers to a state of being recognized as white and nearly white to the human eye, which does not necessarily have to be a state of exhibiting perfect white on chromatics.

According to this configuration, at one of a first half and a latter half of a time period in which one frame is displayed in the display element, by causing the light, which has been emitted from the first light source emitting light of the first color, to pass thorough the color filter having at least either color of the second color and the third color, the graduation display of the complementary colors of the third color and the second color can be performed at each pixel for which the corresponding color filter is formed. Thus, it is possible to obtain a display device capable of realizing a wide color reproduction region and high color purity while maintaining a configuration of a display element having a high resolution and a high numerical aperture.

Further, preferably, at an other of the first half and the latter half of the time period in which one frame is displayed in the display element, the data line driving portion supplies a data signal for causing each in the group of pixel portions among the pixel portions that corresponds to the color filter of the first color to perform a black display to a corresponding one of the data lines. Furthermore, preferably, when, at one of a first half and a latter half of a time period in which one frame is displayed in the display element, a data signal to be written into either one of the group of pixel portions that corresponds to the color filter of the second color and the group of pixel portions that corresponds to the color filter of the third color is supplied to corresponding one of the data lines, at said one of the first half and the latter half of the time period in which one frame is displayed in the display element, to data lines corresponding to the other one of said groups, which are not supplied with the data signal, among the groups of pixel portions that corresponds to the color filter of the second color or the groups of pixel portions that corresponds to the color filter of the third color, the data line driving portion supplies a data signal for causing a pixel portion to perform a black display.

With this configuration in which at each of a first half and a latter half of a time period in which one frame is displayed in the display element, a pixel portion of a color not to be displayed is caused to perform a black display, it is possible to prevent the generation of leakage light, thereby allowing further improved color purity to be obtained.

Further, in the above-described configuration, the illumination device preferably is further modified so that a plurality of the first light sources and a plurality of the second light sources are provided in a direction orthogonal to the scanning lines, and at one of the first half and the latter half of the time period in which one frame is displayed in the display element, the light source driving portion switches on the plurality of the first light sources successively in an order of arrangement so as to be synchronized with an application of the selection signal to each of the scanning lines, and at an other of the first half and the latter half of the time period in which one frame is displayed in the display element, the light source driving portion switches on the plurality of the second light sources successively in an order of arrangement so as to be synchronized with the application of the selection signal to each of the scanning lines.

This configuration is preferable because light from the first light source and light from the second light source, these light sources being arranged in dose proximity to each other, are prevented from being mixed with each other, thereby allowing further improved color purity to be obtained.

Further, in the above-described configuration, preferably, an interpolation data generating portion further is provided that generates a data signal to be supplied to one of the data lines at the latter half of the time period in which one frame is displayed in the display element by performing interpolation between a data signal to be supplied to the one of the data lines in said time period and a data signal to be supplied to the one of the data lines in a time period subsequent to said time period. Furthermore, preferably, an interpolation data generating portion further is provided that generates a data signal to be supplied to one of the data lines at the first half of the time period in which one frame is displayed in the display element by performing interpolation between a data signal to be supplied to the one of the data lines in said time period and a data signal to be supplied to the one of the data lines in a time period one frame prior to said time period. This is preferable because, particularly, in the case where a moving picture is displayed, the occurrence of a color breaking phenomenon can be suppressed.

Furthermore, in the above-described configuration, preferably, the light of the first color has a spectrum principally in a wavelength region of green, the light of the second color has a spectrum principally in a wavelength region of red, and the light of the third color has a spectrum principally in a wavelength region of blue.

Thus, the color filter having a spectrum in a wavelength region of green can be prevented from being mixed with the light of the backlight having wavelength regions of blue and red, whereby the color purity can be improved. At the same time, while the first light source is switched on, a multicolor display of five colors of RGBCY can be performed using the color filters of three colors of RGB by inputting an image display signal corresponding to yellow (Y) into pixels provided with the red color filter, and inputting an image display signal corresponding to cyan (C) into pixels provided with the blue color filter.

Furthermore, the above-described configuration may be such that the light of the first color has a spectrum principally in a wavelength region of blue, the light of the second color has a spectrum principally in a wavelength region of red, and the light of the third color has a spectrum principally in a wavelength region of green.

By doing so, the multicolor display of five colors of RGBCM can be performed using the color filters of three colors of RGB.

In the above-described configuration, preferably, each of the first light source and the second light source is a cold cathode fluorescent tube or a hot cathode fluorescent tube. Moreover, in this configuration, preferably, a plurality of the first light sources and a plurality of the second light sources are provided and arranged so as to alternate with each other one by one or in sets of a plural number of the first or second light sources.

Further, the above-described configuration may be such that the first light source is a green light-emitting diode, and the second light source is formed of a combination of a red light-emitting diode and a blue light-emitting diode that emits light at a same time that the red light-emitting diode emits light. Alternatively, the above-described configuration also may be such that the first light source is a blue light-emitting diode, and the second light source is formed of a combination of a red light-emitting diode and a green light-emitting diode that emits light at a same time that the red light-emitting diode emits light.

Furthermore, the configuration may be such that the first light source is a green light-emitting diode, and the second light source is formed of a combination of a blue light-emitting diode and a magenta light-emitting element that is formed of a phosphor that emits red light when excited by blue light of the blue light-emitting diode.

Hereinafter, the illumination device and the display device according to the present invention will be described by way of preferred embodiments with reference to the appended drawings. While being directed to an exemplary case where a television receiver including a transmission type liquid crystal display element is used as the display device according to the present invention, the following description is not intended to limit an application scope of the present invention. As the display element according to the present invention, for example, a semi-transmission type liquid crystal display element can be used. Further, the applications of the display device according to the present invention are not limited only to a television receiver.

### First Embodiment

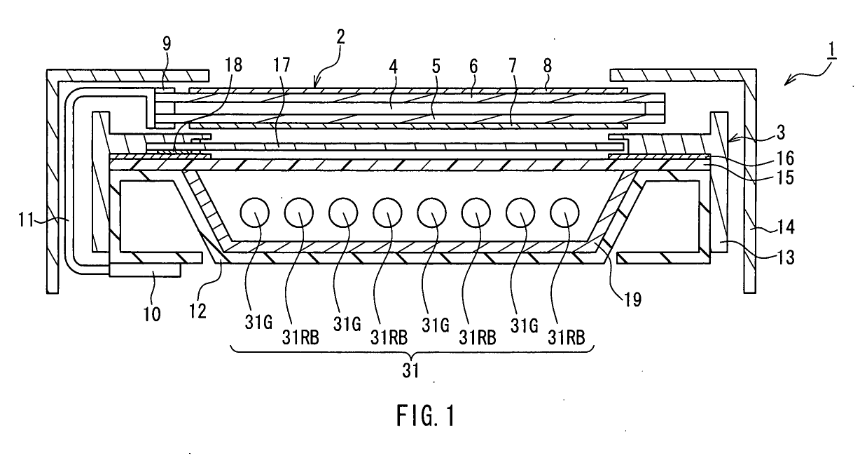

FIG. 1 is a schematic cross-sectional view illustrating an illumination device and a liquid crystal display device provided with the same according to Embodiment 1 of the present invention. As shown in FIG. 1, in a liquid crystal display device 1 according to the present embodiment, there are provided a liquid crystal panel 2 (display element) that is located with an upper side of FIG. 1 defined as a viewing side (display surface side) and a backlight device 3 (illumination device) that is disposed on a non-display surface side of the liquid crystal panel 2 (lower side of FIG. 1) and irradiates the liquid crystal panel 2 with plane-shaped light are provided.

The liquid crystal panel 2 includes a liquid crystal layer 4, a pair of transparent substrates 5 and 6 that sandwich the liquid crystal layer 4 therebetween, and polarizing plates 7 and 8 that are provided on the respective outer surfaces of the transparent substrates 5 and 6, respectively. Further, in the liquid crystal panel 2, a driver 9 (a gate driver or a source driver to be described later) for driving the liquid crystal panel 2 and a drive circuit 10 that is connected to the driver 9 via a flexible printed board 11 are provided.

The liquid crystal panel 2 is an active matrix type liquid crystal panel and is configured so that supplying a scanning signal and a data signal respectively to scanning lines and data lines that are arranged in a matrix form allows the liquid crystal layer 4 to be driven on a pixel basis. Specifically, when a TFT (switching element) provided in the vicinity of each of intersections of the scanning lines and the data lines is brought to an ON state based on a signal of a corresponding one of the scanning lines, a data signal is written from a corresponding one of the data lines into a pixel electrode, and an alignment state of liquid crystal molecules changes in accordance with a potential level of the data signal, and thus each pixel performs a gradation display in accordance with a data signal. In other words, in the liquid crystal panel 2, a polarization state of light made incident from the backlight device 3 through the polarizing plate 7 is modulated by the liquid crystal layer 4, and an amount of light passing through the polarizing plate 8 is controlled, and thus a desired image is displayed.

In the backlight device 3, a bottomed case 12 that is open on the liquid crystal panel 2 side and a frame-shaped frame 13 that is located on the liquid crystal panel 2 side of the case 12 are provided. Further, the case 12 and the frame 13 are made of a metal or a synthetic resin and are held within a bezel 14 having an L shape in cross section with the liquid crystal panel 2 located above the frame 13. The backlight device 3 thus is combined with the liquid crystal panel 2, and the backlight device 3 and the liquid crystal panel 2 are integrated as the liquid crystal display device 1 of a transmission type in which illumination light from the backlight device 3 is made incident on the liquid crystal panel 2.

Furthermore, the backlight device 3 includes a diffusing plate 15 that is located so as to cover an opening of the case 12, an optical sheet 17 that is located above the diffusing plate 15 on the liquid crystal panel 2 side, and a reflecting sheet 19 that is provided on an inner surface of the case 12. Further, in the backlight device 3, a plurality of cold cathode fluorescent tubes 31 are provided above the reflecting sheet 19, and light from these cold cathode fluorescent tubes 31 is irradiated toward the liquid crystal panel 2 as plane-shaped light. It should be noted that, although FIG. 1 shows, for the sake of simplicity, a configuration including eight cold cathode fluorescent tubes 31, the number of the cold cathode fluorescent tubes 31 is not limited thereto.

These plurality of the cold cathode fluorescent tubes 31 include a cold cathode fluorescent tube 31G in which a green phosphor is sealed so that an emission spectrum of the cold cathode fluorescent tube 31G has a peak in a wavelength region of green as a light source that emits light of a first color, and a cold cathode tube 31RB in which red and blue phosphors are sealed so that an emission spectrum of the cold cathode tube 31RB has peaks in a wavelength region of red and in a wavelength region of blue, respectively, as a light source that emits light of magenta (M: the mixed color of red and blue), which is complementary to the first color, green.

The cold cathode tubes 31G and 31RB are arranged so that a longitudinal direction thereof is parallel to an extending direction of the scanning lines of the liquid crystal panel 2. It should be noted that, although FIG. 1 shows an example in which the cold cathode fluorescent tubes 31G and the cold cathode fluorescent tubes 31RB are arranged so as to alternate with each other one by one, the cold cathode fluorescent tubes 31G and the cold cathode fluorescent tubes 31RB also may be arranged so as to alternate with each other in sets of a plural number (for example, two) of the cold cathode fluorescent tubes 31G or 31RB.

The number of the cold cathode fluorescent tubes 31 is set suitably in accordance with the screen size of the liquid crystal display device 1, the brightness of each type of the fluorescent tubes, and the like. As one example, in the case where the liquid crystal display device 1 has a screen size of a so-called 37V type, it is preferable to have a configuration that includes about 18 cold cathode fluorescent tubes in total composed of 9 cold cathode fluorescent tubes 31G and 9 cold cathode fluorescent tubes 31RB.

The diffusing plate 15 that is made of, for example, a synthetic resin or a glass material diffuses light from the cold cathode fluorescent tubes 31 (containing light reflected off the reflecting sheet 19) and outputs it to the optical sheet 17 side. Further, the four sides of the diffusing plate 15 are mounted on a frame-shaped surface provided on an upper side of the case 12, and the diffusing plate 15 is incorporated in the backlight device 3 while being sandwiched between said surface of the case 12 and an inner surface of the frame 13 via a pressure member 16 that is deformable elastically.

The optical sheet 17 includes a condensing sheet formed of, for example, a synthetic resin film and is configured so as to increase the brightness of illumination light from the backlight device 3 to the liquid crystal panel 2. Further, on the optical sheet 17, optical sheet materials such as a prism sheet, a diffusing sheet, a polarizing sheet and the like are laminated suitably as required for the purpose of for example, improving display quality on a display surface of the liquid crystal panel 2. The optical sheet 17 is configured so as to convert light outputted from the diffusing plate 15 into plane-shaped light having a uniform brightness not lower than a predetermined brightness (for example, 10,000 cd/m²) and make it incident as illumination light on the liquid crystal panel 2. In addition to the above-described configuration, for example, optical members such as a diffusing sheet and the like for adjusting a viewing angle of the liquid crystal panel 2 may be laminated suitably above the liquid crystal panel 2 (on the display surface side).

The reflecting sheet 19 is formed of, for example, a thin film of a metal having a high light reflectance such as aluminum, silver or the like and functions as a reflecting plate that reflects light from the cold cathode fluorescent tubes 31 toward the diffusing plate 15. Thus, in the backlight device 3, the use efficiency and brightness at the diffusing plate 15 of light from the cold cathode fluorescent tubes 31 can be increased. It should be noted that, in place of the above-described metal thin film, a reflecting sheet material made of a synthetic resin may be used, or alternatively, for example, a coating of a white paint or the like having a high light reflectance may be applied to the inner surface of the case 12 so that said inner surface functions as a reflecting plate.

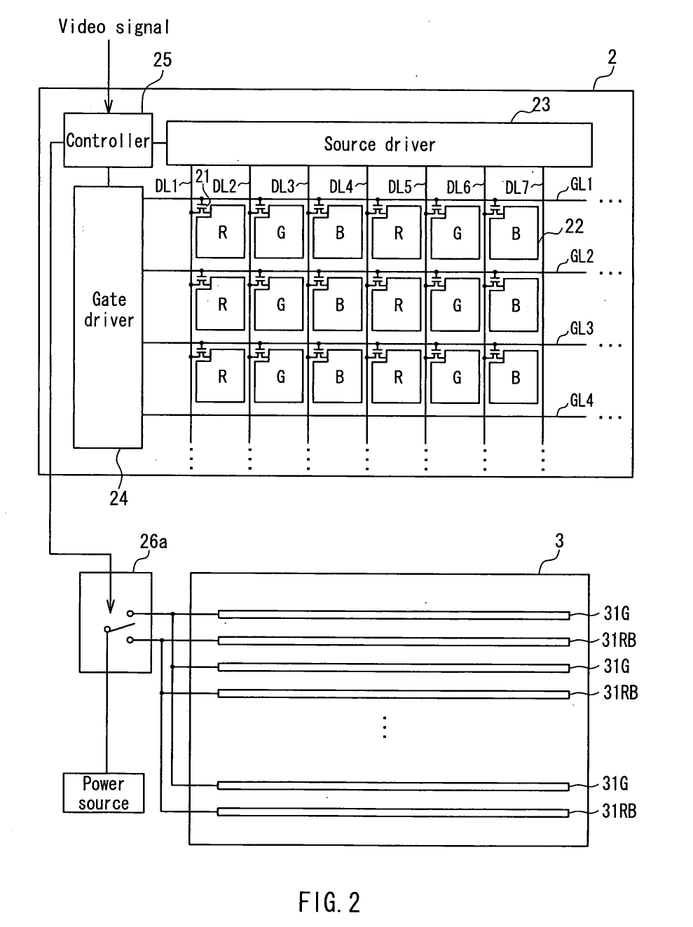

Hereinafter, the configurations of the liquid crystal panel 2 and the backlight device 3 in the liquid crystal display device 1 and methods of driving them will be described in more detail with reference to FIG. 2. FIG. 2 is a diagram schematically showing a functional relationship between the liquid crystal panel 2 and the backlight device 3 but is not intended to faithfully represent the physical sizes of the liquid crystal panel 2 and the backlight device 3.

As described above, the liquid crystal panel 2 is an active matrix type liquid crystal display element, and as shown in FIG. 2, it includes scanning lines GL and data lines DL that are arranged in a matrix form, a TFT 21 that is disposed at each of intersections of the scanning lines GL and the data lines DL, a pixel electrode 22 that is connected to a drain electrode of the TFT 21, a gate driver 24 that sequentially supplies a selection signal to the scanning lines GL, a source driver 23 that supplies a data signal to each of the data lines, and a controller 25 that supplies a clock signal, a timing signal and the like to the source driver 23, the gate driver 24 and the like.

Furthermore, the liquid crystal display device 1 includes a switch circuit 26 that controls switching on/off of the cold cathode fluorescent tubes 31G and 31RB of the backlight device 3 in accordance with, for example, a timing signal supplied from the controller 25. The switch circuit 26 controls switching on/off of the cold cathode fluorescent tubes 31G and 31RB through ON/OFF of voltage supply from an alternating-current power source or the like to the cold cathode fluorescent tubes 31G and 31IRB. In the present embodiment, the switch circuit 26 is configured so that ON/OFF of all the plurality of the cold cathode fluorescent tubes 31G are controlled simultaneously, and ON/OFF of all the plurality of the cold cathode fluorescent tubes 31RB also are controlled simultaneously.

The configurations of the drivers and controller shown in FIG. 2 are merely illustrative, and modes of mounting these driving system circuits are arbitrary. For example, these driving system circuits may be provided so that at least a part of them is formed monolithically on an active matrix substrate; they may be mounted as semiconductor chips on a substrate; or alternatively, they may be connected as external circuits of the active matrix substrate. Further, the switch circuit 26 may be provided on either of the liquid crystal panel 2 and the backlight device 3.

On an opposing substrate (not shown) opposed to this active matrix substrate, color filter layers of three colors of RGB are formed in stripes. In the present embodiment, a first color is green (G); a second color is red (R); and a third color is blue (B). In FIG. 2, the colors of the color filters corresponding respectively to pixels are denoted by characters “R”, “G”, and “B”. Thus, as shown in FIG. 2, all of pixels in one column connected to the same data line DL display one of the colors of RGB. For example, in FIG. 2, all of pixels connected to the data line DL1 display red. Although the color filters described herein are in a stripe arrangement, other types of arrangements such as a delta arrangement also may be adopted.

In the liquid crystal panel 2 configured as above, when a gate pulse (selection signal) having a predetermined voltage is applied sequentially to the scanning lines GL1, GL2, GL3, GL4, . . . , each of the TFTs 21 connected to one of the scanning lines GL, to which the gate pulse has just been applied, is brought to an ON state, and a value of a gradation voltage that has been applied to a corresponding one of the data lines DL at that point in time is written into the each of the TFTs 21. Consequently, a potential of the pixel electrode 22 connected to a drain electrode of the each of the TFTs 21 becomes equal to the value of the gradation voltage of the corresponding one of the data lines DL. As a result of this, an alignment of liquid crystals interposed between the pixel electrode 22 and an opposing electrode changes in accordance with the value of the gradation voltage, and thus a gradation display of said pixel is realized. On the other hand, during a time period in which a non-selection voltage is applied to the scanning lines GL, the TFTs 21 are brought to an OFF state, so that the potential of the pixel electrode 22 is maintained at a value of a potential applied thereto at the time of writing.

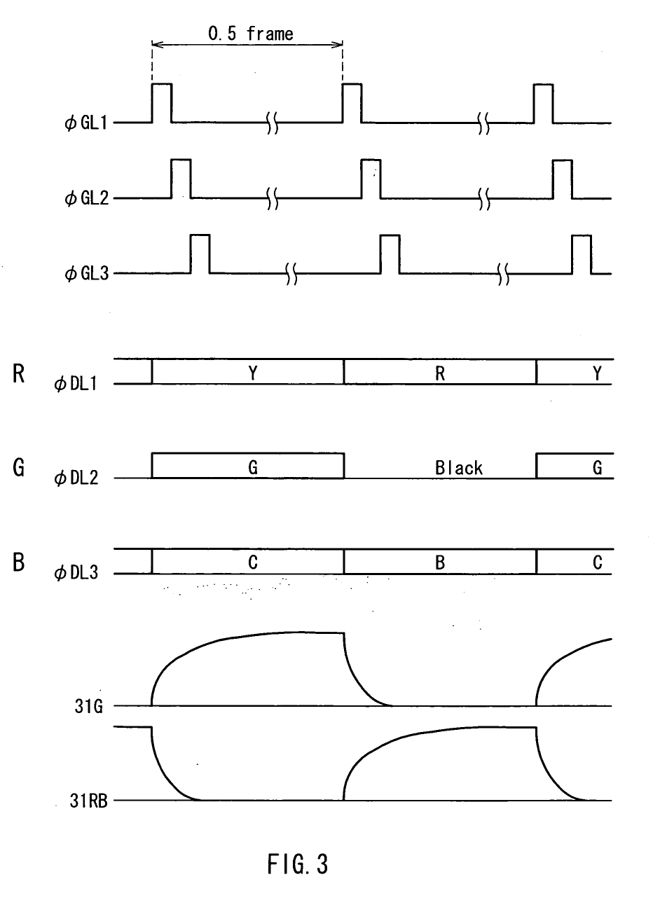

In the liquid crystal display device 1 according to the present embodiment, which is configured as above, as shown in FIG. 3, the gate driver 24 applies a gate pulse to each of the scanning lines GL at a cycle of ½ of a time period (one frame time period) in which one frame is displayed in the liquid crystal panel 2. In FIG. 3, the first to third graphs from the top representatively show states of the scanning lines up to GL1, GL2 and GL3 in which a gate pulse is applied sequentially. In a 0.5 frame time period that is equivalent to a half of one frame, a gate pulse is sequentially applied to the last scanning line formed in the liquid crystal panel.

At a first half of this one frame time period, the switch circuit 26 switches on the cold cathode fluorescent tubes 31G that emit green light and switches off the cold cathode fluorescent tubes 31RB. Further, at a latter half of one frame time period, the switch circuit 26 switches off the cold cathode fluorescent tubes 31G that emit green light and switches on the cold cathode fluorescent tubes 31RB. In FIG. 3, the first and second graphs from the bottom show amounts of light emitted by the cold cathode fluorescent tubes 31RB and 31G, respectively.

At the first half of one frame time period, the source driver 23 supplies a data signal to be applied to a green pixel to each of the data lines DL2, DL5, DL8, . . . that are connected to a group of pixel electrodes 22 among the pixel electrodes 22 that corresponds to the green color filter.

At the same time, the source driver 23 supplies a data signal to be applied to a red pixel to each of the pixel data lines DL1, DL4, DL7, . . . , which are connected to the pixel electrodes 22 that correspond to the red color filters. Here, since the filter formed on the pixel is red while the light source to be switched on is the cold cathode fluorescent tubes 31G, which emit green light as a first light source, the color actually displayed on the pixel is the mixed color of red and green, which is yellow (Y). Therefore, a data signal to be applied to the red pixel while the green cold cathode fluorescent tubes 31G are switched on is based on a signal for display with a yellow pixel.

Similarly, the source driver 23 supplies a data signal to be applied to a blue pixel to each of the pixel data lines DL3, DL6, DL9, . . . , which are connected to a group of pixel electrodes 22 among the pixel electrodes 22 that corresponds to the blue color filter. Since the light emitted from the green light source is transmitted through the blue color filter, the color actually displayed on the pixel is cyan (C). Therefore, a data signal to be applied to the blue pixel while the green cold cathode fluorescent tubes 31G are switched on is based on a signal for display with a cyan pixel.

By the operations described above, at a first half of one frame time period, green pixels, as well as yellow and cyan pixel portions in one frame are displayed.

Further, at the latter half of one frame time period, the source driver 23 supplies a data signal to be applied to a red pixel to each of the data lines DL1, DL4, DL7, . . . that are connected to a group of pixel electrodes 22 among the pixel electrodes 22 that corresponds to the red color filter, and also supplies a data signal to be applied to a blue pixel to each of the data lines DL3, DL6, DL9, . . . that are connected to a group of pixel electrodes 22 among the pixel electrodes 22 that corresponds to the blue color filter. Thus, at the latter half of one frame time period, only portions constituted of red pixels and blue pixels in one frame are displayed.

For example, in the case where a data signal is a video signal according to the NTSC standards, the refreshing rate is 60 Hz and the length of one frame time period is 16.7 milliseconds. Therefore, in the case where at a first half of one frame time period, green, cyan and yellow pixel portions are displayed, and at a latter half thereof, red and blue pixel portions are displayed as described above, due to the persistence of vision, a resulting image is recognized to the human eye as an image in which five colors composed of three primary colors of RGB+cyan+yellow are mixed.

In the liquid crystal display device 1 of the present embodiment, at the latter half of one frame time period, while the cold cathode fluorescent tubes 31RB that emit magenta light, the mixed color of blue and red, are switched on, a data signal to cause a black display is supplied to each of the data lines DL2, DL5, DL8, . . . that are connected to a group of pixel electrodes 22 among the pixel electrodes 22 that corresponds to the green color filter. This is because the black display allows unwanted leakage light from a pixel portion to be blocked.

Possible reasons for such leakage light are that an ON/OFF signal of a drive circuit of the cold cathode fluorescent tubes is delayed or dull, or an ON/OFF delay of the cold cathode fluorescent tubes. That is, a cold cathode fluorescent tube has a characteristic that an amount of light emitted thereby does not immediately change in response to the control of switching on/off.

For example, as shown in the first and second graphs from the bottom in FIG. 3, when the switching of the switch circuit 26 is controlled depending on which cold cathode fluorescent tubes should be switched on at a first half and a latter half of one frame time period, an amount of light emitted by either the cold cathode fluorescent tubes 31G or the cold cathode fluorescent tubes 31RB that are thereby switched off does not become zero immediately after the switching by the switch circuit 26. Because of this, it is preferable that not only the cold cathode fluorescent tubes 31G emitting green light and the cold cathode fluorescent tubes 31RB emitting magenta light, which are the first light source and the second light source, respectively, are simply switched off, but also a data signal to cause a black display is supplied to the data lines connected to each of the pixel electrodes 22.

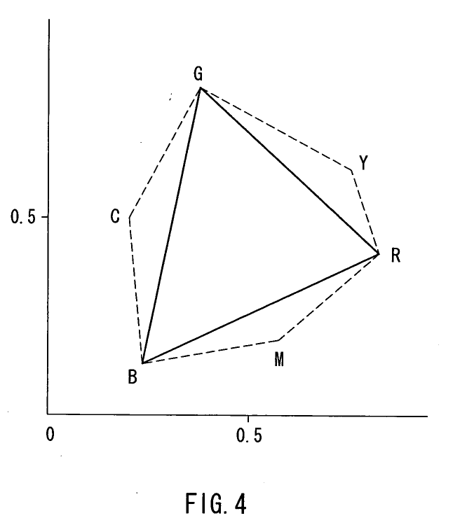

Here, with reference to FIG. 4, the principle of the present invention will be described in which in an image display is enabled in a wide color reproduction region by a combination of pixels for which color filters of three primary colors of RGB are formed; a first light source that emits light of a first color that is one of the three primary colors of RGB; and a second light source that emits light of a color complementary to the first color.

FIG. 4 shows a relationship between the three primary colors of RGB and the three primary colors of CMY that are complementary to the colors of RGB, respectively. This figure is illustrated based on a x-y chromaticity diagram. As shown in FIG. 4, a mixed color of green (G) and blue (B) is cyan (C); a mixed color of green (G) and red (R) is yellow (Y); and a mixed color of blue (B) and red (R) is magenta (M).

Normally, when a color of the mixed light obtained by mixing the three primary colors of RGB is expressed on a chromaticity diagram, a chromatic coordinate of the mixed color is to be located inside a triangle having apexes at the chromatic coordinates of the three colors of RGB, which are original colors of the mixed color. Therefore, in the conventional display device having pixels of the three colors of RGB, with a method in which any two of the three primary colors of RGB are lighted simultaneously in order to display the respective colors of cyan, yellow, and magenta, it is impossible to extend the tones of neutral colors to the outside of the triangle that the chromatic coordinates of the three colors of RGB form on the chromaticity diagram. For example, in the case where cyan is displayed by switching on green and blue pixels, even cyan having the highest color purity possible is extended up to a point on the segment connecting G and B on the chromaticity diagram image shown in FIG. 4.

Further, even in a method in which filters of respective colors of cyan, yellow, and magenta are formed for the pixels in addition to the filters of the three primary colors of RGB, since a white light source is used as a light source, it has been difficult to avoid a decrease in color purity due to the overlap of the wavelength distributions of the light transmitted through the respective color filters of R, G, B, C, Y and M. Further, since a three-band tube or a four-band tube typically is used as a white light source, it cannot be said that the color reproduction region thereof is inherently wide enough. Furthermore, since the three-band tube or the four-band tube produces the white color by mixing peak wavelengths of light of the three primary colors of RGB, it has been more difficult to sufficiently adjust the transmitted light wavelength characteristics of the respective color filters of cyan, yellow, and magenta than adjusting those of the three primary colors of RGB.

With respect to this problem, first, the display device according to the present invention can improve the color purity of the three primary colors of RGB themselves. This is because each of the three primary colors of RGB in the display device according to the present invention is a color obtained in such a manner that light emitted by the first light source or the second light source has been transmitted through the color filter formed on the corresponding pixel. Specifically, for example, in the case of Embodiment 1, G (green) is a color of green obtained in such a manner that green light emitted by the first light source has been transmitted through the pixel provided with the color filter of green, which is the first color, and then is displayed on the screen. Further, R (red) and B (blue) are colors of red and blue obtained in such a manner that magenta light emitted by the second light source has been transmitted through the pixels provided with the color filters of red and blue, which are the second color and the third color, respectively, and then are displayed on the screen. Because of this, among the respective three primary colors of RGB, the color mixing that occurs due to the overlap of the transmitted light wavelength characteristics of the respective color filters can be prevented effectively.

Still further, also when displaying the respective colors of cyan, yellow, and magenta, the display device according to the present invention can extend the color reproduction region. For example, when cyan is displayed on the liquid crystal display device of Embodiment 1, the light of green, which is the first color, emitted by the first light source, is displayed as a color having been transmitted through the pixel provided with the color filter of blue, which is the third color. Therefore, the light thus obtained has a wavelength spectrum limited to an overlapped portion of the emission spectrum of the first light and the wavelength distributions of the light transmitted through the blue color filter. This color is not the mixed color of green and blue of the three primary colors displayed on the display device according to the present invention, and therefore, can belong to a wider color reproduction region, i.e., the outside of the triangle formed by the chromatic coordinates of the three primary colors of RGB as shown in FIG. 4.

In the case of yellow shown in Embodiment 1, the light of green, which is the first color, emitted by the first light source is displayed as a color having been transmitted through the pixel provided with the color filter of red, which is the second color. Because of this, as to yellow also, the color reproduction region of the same extends more broadly of yellow obtained by the mixing of colors of green and red of the three primary colors displayed on the display device and, similarly to the case of cyan, the region can be extended to the outside of the triangle formed by the chromatic coordinates of the three primary colors of RGB on the chromaticity diagram.

Furthermore, for example, in the case where blue is a first light, magenta exhibiting a wider color reproduction range than that of magenta obtained by the mixing of colors of red and blue of the three primary colors to be displayed by the display device can be displayed by causing the blue light emitted by the first light source to be transmitted through the pixel provided with the red color filter, although this cannot be realized in Embodiment 1 with green as the first light.

Next, the following describes what kind of the color reproduction actually is realized by the display device according to the present embodiment.

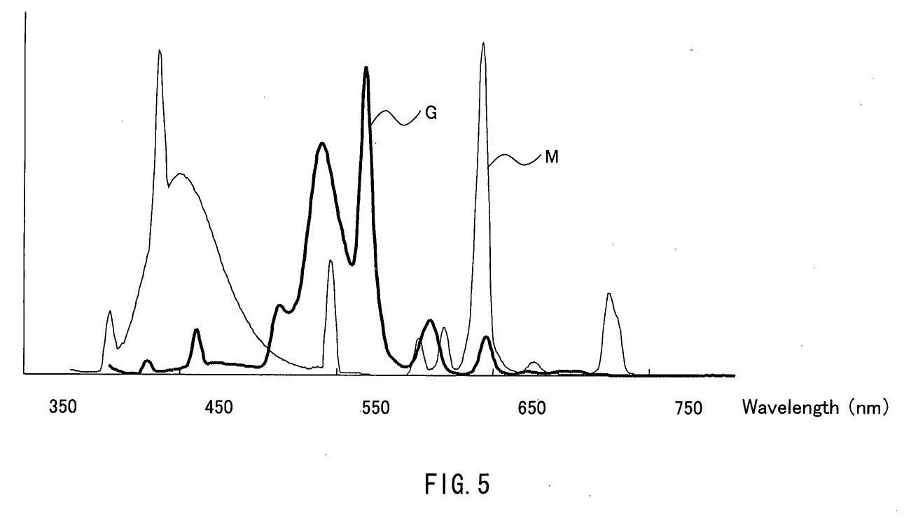

As Example 1, FIG. 5 shows emission spectrum distribution of a cold cathode fluorescent tube 31G as a first light source and a cold cathode fluorescent tube 31RB as a second light source for a backlight device 3 used in the display device according to the present embodiment. In FIG. 5, a bold solid line represents the emission spectrum distribution of the first light source emitting green, and a thin solid line represents the emission spectrum distribution of the second light source emitting magenta.

A phosphor that is applied on the green cold cathode fluorescent tube 31G, i.e., the first light source, is a blend of 50% of “Lap phosphor (composition LaPO₄: Ce, Tb, peak wavelength=540 nm, manufactured by Nichia Corporation, NP-220 [product name])” and 50% of “BAM: Mn phosphor (composition BaMgAl₁₀Oₙ: Eu, Mn, peak wavelength=516 nm, manufactured by Nichia Corporation, NP-108 [product name])”. Further, as to phosphors applied on the magenta cold cathode fluorescent tube 31RB, i.e., the second light source, the blue phosphor is “BAM phosphor (composition BaMgAl₁₀O₁₇: Eu, peak wavelength=450 nm, manufactured by Nichia Corporation, NP-107 [product name])” and the red phosphor is “YVO phosphor (composition Y (P, V)O₄: Eu, peak wavelength=620 nm, manufactured by Nichia Corporation, NP-310 [product name])”, and the blend ratio thereof is 50%:50%.

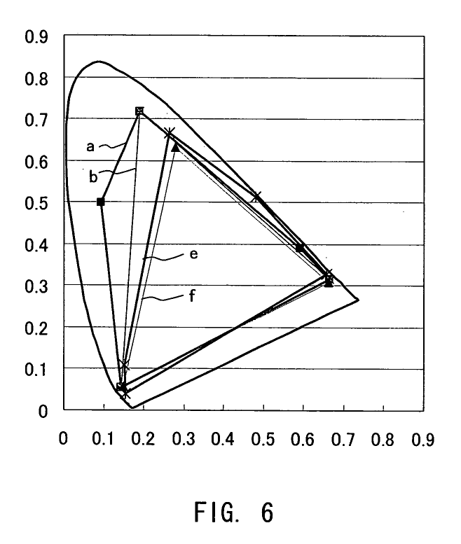

FIG. 6 shows color reproduction ranges of the display device of Example 1 according to the present embodiment and other display devices illustrated on a chromaticity diagram. Here, “a” indicates a color reproduction range of the display device according to the embodiment of the present invention.

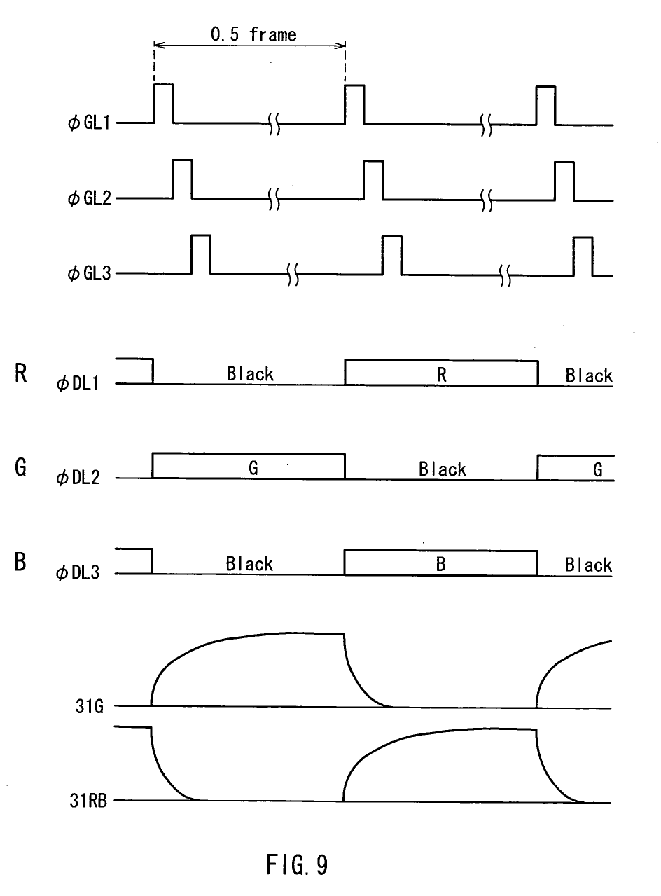

In FIG. 6, “b” indicates a color reproduction range of Comparative Example 1 for comparison with the range of the display device in Example 1 of the present invention. This Comparative Example 1, when compared with Example 1, uses the same backlight device 3 including a first and a second light sources and performs an image display using the same liquid crystal panel 2, but has the following differences: an image display signal is input differently from Example 1; and not the five-color display of RGBCY like the example of the present invention, but the three-primary-color display of RGB is preformed. Specifically, as shown in FIG. 9, while the first light source is switched on, an image display signal of green is supplied as data only to a group of pixels among the pixels provided with the green color filter. At the same time, data to cause a black display are supplied to groups of pixels among the pixels provided with the blue color filter and the red color filter. It should be noted that the operation of inputting signals while the second light source is lit on is identical to that in Example 1 of the present invention.

In FIG. 6, as understood by comparison between the color reproduction range in Example 1 of the present invention indicated by the character “a” and the color reproduction range in Comparative Example 1 indicated by the character “b”, the color reproduction range “a” has a substantially extended portion of cyan in comparison with the color reproduction range “b”, which is triangular because the display is the three-primary-color display. Further, the color reproduction range on a yellow side is also extended, though slightly, in comparison with the range indicated by the character “b” of Comparative Example 1, thereby having a shape of pentagon, as can be seen from the figure.

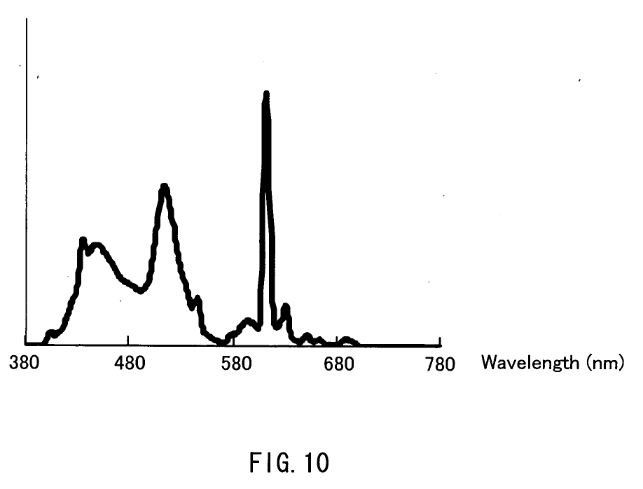

Further, the character “e” in FIG. 6 indicates a color reproduction range of a display device performing the conventional five-color display in which a conventional three-band white backlight having a spectrum distribution shown in FIG. 10 is used and color filters of five colors of RGBCY are formed on a liquid crystal display element. The other character “f” indicates a color reproduction range of the display device performing the conventional three-primary-color display of RGB in which the same three-band white backlight having a spectrum distribution shown in FIG. 10 is used and color filters of the three colors of RGB are formed on the liquid crystal display element.

As can be seen from FIG. 6, the display device of Example 1, which is a display device according to the present invention, surely can extend the color reproduction range of the display image than the case in which the three-primary-color display or the five-color display is performed using the conventional white light, and further than the display device of Comparative Example 1 in which the color display is performed using a first light source emitting light of a first color and a second light source emitting light of a color complementary to the light of the first color, with pixels provided with color filters having colors corresponding to the light from the respective light sources.

When values of the NTSC ratio (CIE 1931 chromatic coordinate), which is one of indexes for comparing the color reproduction range, are noted, the following is shown: when Comparative Example 1 is assumed to have a ratio of 100%, Example 1 has a ratio of 124%, whereas the conventional five-color display indicated by the character “e” in FIG. 6 has a ratio of 97%, and the conventional three-primary-color display indicated by the character “f” in FIG. 6 has a ratio of 83%. This proves well that the display device according to the present invention has a wide color reproduction range.

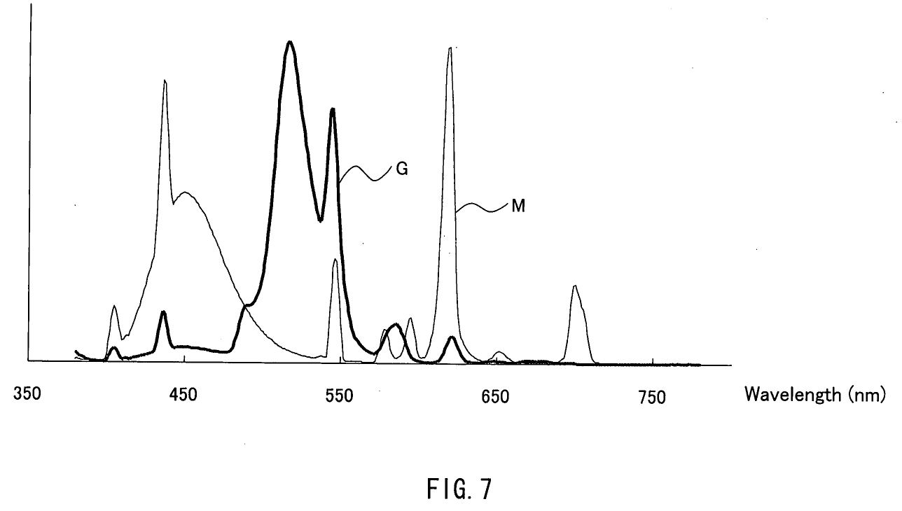

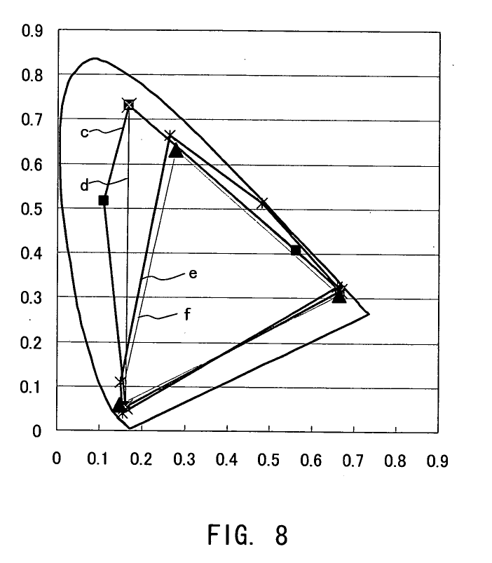

Next, a display device of Example 2 according to the present invention will be described with reference to FIGS. 7 and 8. This display device of Example 2 is identical to that of the above-described Example 1 shown in FIGS. 5 and 6, except that the blend ratios of the phosphors used in the first light source and the second light source for the backlight device 3 are different. Specifically, in Example 2, the blend ratio of the phosphors in the first light source emitting green light is 67% of “Lap phosphor” and 33% of “BAM: Mn phosphor”. Further, the blend ratio of the phosphors in the second light source emitting magenta is 52% of blue “BAM phosphor” and 48% of red “YVO phosphor”.

FIG. 7 shows emission spectrum distributions of a cold cathode fluorescent tube 31G as a first light source and a cold cathode fluorescent tube 31RB as a second light source in this Example 2. In FIG. 7, the bold solid line represents the emission spectrum distribution of the first light source emitting green, and the thin solid line represents the emission spectrum distribution of the second light source emitting magenta. It can be seen that, compared to the spectrum distribution of the light sources in Example 1 shown in FIG. 5, the spectrum distribution of the first light source emitting green particularly has a different peak shape.

FIG. 8 shows a color reproduction range in Example 2 of the display device according to the present embodiment. The character “c” in FIG. 8 indicates the color reproduction range in Example 2. The character “d” in FIG. 8 indicates a color reproduction range of Comparative Example 2. Similarly to the case of Example 1 and Comparative Example 1 as described using FIG. 6, Comparative Example 2 has the same configuration as that of Example 2 regarding the first light source and second light source for the backlight device 3 and the color filters of the liquid crystal panel 2 as the display element, but Comparative Example 2 is different from Example 2 in that the three-primary-color display of RGB is driven by a driving method shown in FIG. 9. Similarly to FIG. 6, the character “e” indicates the color reproduction range of the display device performing the conventional five-color display in which the three-band white backlight having a spectrum distribution shown in FIG. 10 is used and the color filters of five colors of RGBCY are formed on the liquid crystal display element, and the character “f” indicates the color reproduction range of the display device performing the conventional three-primary-color display of RGB in which the same three-band white backlight is used and the color filters of the three colors of RGB are formed on the liquid crystal display element.

It can be perceived that, as is clear from FIG. 8, the color reproduction range of the display device according to the present invention also is wider than those adopting the other methods, though it is slightly different from that in Example 1 shown in FIG. 6, because of a difference between the blend ratios of the phosphors used in the first light source and the second light source. When values of the above-described NTSC ratio (CIE 1931 chromatic coordinate), which is one of indexes for comparing the color reproduction range, are noted, the following is shown: when Comparative Example 1 is assumed to have a ratio of 100%, Example 2 has a ratio of 120%. In comparison with the conventional five-color display indicated by the character “e” having a ratio of 97%, and the conventional three-primary-color display indicated by the character “f” having a ratio of 83%, the color reproduction range of Example 2 can be well understood to be wide.

It should be noted that, although in the above-described embodiment of the present invention, red and blue are specified as the second color and the third color, unlike the first color as the color of light of the first light source, these second color and third color may be replaced with each other, which apparently does not affect the effects brought by the display device according to the present embodiment.

Further, as the above-described embodiment of the present invention, an exemplary case is shown in which the five-color display is performed with a data signal for an image display being supplied to both of a group of pixel portions among the pixel portions that is provided with the color filter of the second color and a group of pixel portions among the pixel portions that is provided with the color filter of the third color while the first light source emitting light of the first color is switched on. However, the present invention is not limited to this, and a four-color display may be performed with a data signal for an image display being supplied to either one of a group of pixel portions among the pixel portions that corresponds to the second color and a group of pixel portions among the pixel portions that corresponds to the third color. In this case, as described above, it is preferable that a data signal to cause a black display is supplied to a group of pixel portions among the pixel portions that is not to be supplied with the data signal for an image display so that unwanted leakage light is prevented.

It should be noted that the supply of a gate pulse at a cycle of 0.5 frames increases a frame refresh rate. The liquid crystal display device according to the present embodiment, however, is still feasible sufficiently since liquid crystals can have a response speed that conforms to the refreshing rate at a frame rate of NTSC, PAL or the like.

### Embodiment 2

The following describes an illumination device and a liquid crystal display device provided with the same according to Embodiment 2 of the present invention. In the following description, configurations having functions similar to those of the configurations described in Embodiment 1 are denoted by the same reference numerals, and duplicate descriptions of the same are omitted.

The liquid crystal display device according to the present embodiment is different from the liquid crystal display device according to Embodiment 1 in that cold cathode fluorescent tubes 31G of a backlight device 3 are switched on successively in an order of arrangement so as to be synchronized with scanning of scanning lines in a liquid crystal panel 2, and so are cold cathode fluorescent tubes 31RB of the backlight device 3. It should be noted that the following configuration herein is identical to that in Embodiment 1: at a first half of one frame time period, a data signal of yellow is supplied to, among data lines DL, those connected to red pixels, a data signal of green is supplied to those connected to green pixels, and a data signal of cyan is supplied to those connected to blue pixels; and at a latter half of one frame time period, a data signal of red is supplied to those connected to red pixels, and a data signal of blue is supplied to those connected to blue pixels.

Herein, the above-described expression “so as to be synchronized” means that in a 0.5 frame time period, the cold cathode fluorescent tubes 31G or 31RB are switched on sequentially from an upper side toward a lower side of a screen of the liquid crystal panel 2 so as to substantially track each one of scanning lines GL selected sequentially from the upper side toward the lower side of the screen of the liquid crystal panel 2, and does not necessarily require that timing for selecting the scanning lines GL be matched precisely with timing for switching on the cold cathode fluorescent tubes 31.

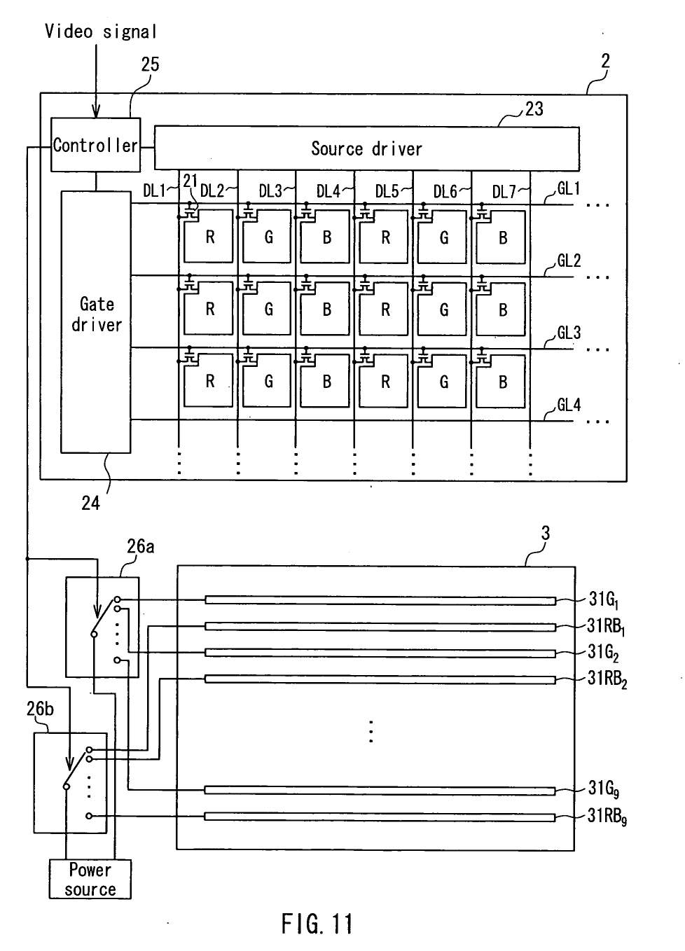

Therefore, as shown in FIG. 11, a liquid crystal display device 20 according to the present embodiment includes, in place of the switch circuit 26 in the liquid crystal display device 1 according to Embodiment 1, a switch circuit 26a that controls switching on/off of the cold cathode fluorescent tubes 31G and a switch circuit 26b that controls switching on/off of the cold cathode fluorescent tubes 31RB. In the following description, it is assumed that the liquid crystal display device 20 includes 18 cold cathode fluorescent tubes in total composed of the cold cathode fluorescent tubes 31G₁ to 31G₉ and the cold cathode fluorescent tubes 31RB₁ to 31RB₉.

At a first half of one frame time period, the switch circuit 26a switches on the cold cathode fluorescent tubes 31G₁ to 31G₉ one by one in this order in accordance with, for example, a timing signal supplied from a controller 25 of the liquid crystal panel 2. That is, in a period of 0.5 frames, the cold cathode fluorescent tubes 31G₁ to 31G₉ are switched on one by one in order from the upper side toward the lower side of the screen of the liquid crystal panel 2 (from the upper side toward the lower side of FIG. 11). In a period of 0.5 frames, the scanning lines GL in the liquid crystal panel 2 are selected in order also in a direction from the upper side toward the lower side of the screen. Thus, at the first half of one frame time period, a position in the liquid crystal panel 2 that generally corresponds to one of the scanning lines GL to which a selection signal is being applied is irradiated with light from a corresponding one of the cold cathode fluorescent tubes 31G.

Furthermore, at a latter half of one frame time period, the switch circuit 26b switches on the cold cathode fluorescent tubes 31RB₁ to 31RB₉ one by one in this order in accordance with, for example, a timing signal supplied from the controller 25 of the liquid crystal panel 2. That is, in a period of 0.5 frames, the cold cathode fluorescent tubes 31 RB₁ to 31RB₉ are switched on one by one in order from the upper side toward the lower side of the screen of the liquid crystal panel 2 (from the upper side toward the lower side of FIG. 11). In a period of 0.5 frames, the scanning lines GL in the liquid crystal panel 2 are selected in order also in the direction from the upper side toward the lower side of the screen. Thus, at the latter half of one frame time period, a position in the liquid crystal panel 2 that generally corresponds to one of the scanning lines GL to which a selection signal is being applied is irradiated with light from a corresponding one of the cold cathode fluorescent tubes 31RB.

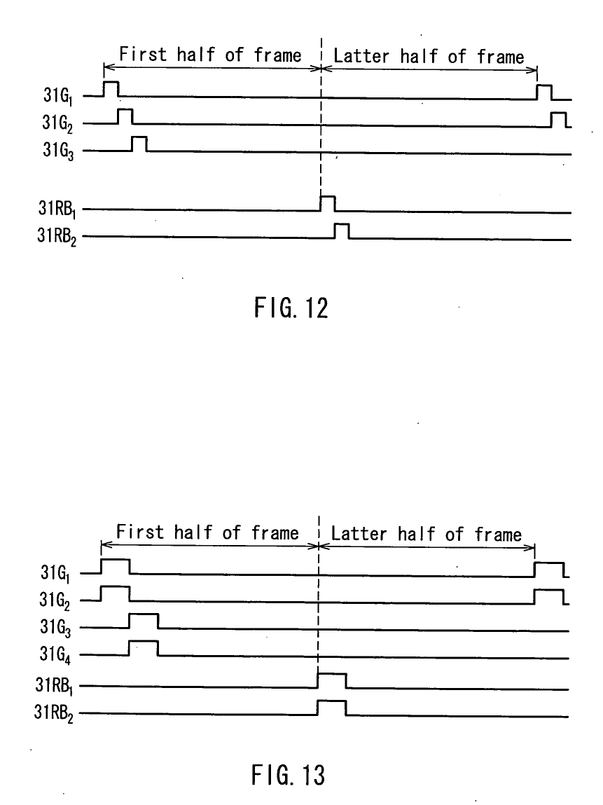

As a result of the above-described control performed by the switch circuits 26a and 26b, as shown in FIG. 12, in one frame time period, the cold cathode fluorescent tubes 31G and 31RB are switched on in an order of 31G₁, 31G₂, 31G₃, . . . 31G₉, 31RB₁, 31RB₂, 31RB₃, . . . 31RB₉. Even though a cold cathode fluorescent tube has a characteristic that an amount of light emitted thereby does not immediately change in response to the control of switching on/off as described above, in the present embodiment, there is no possibility that light is emitted simultaneously by any combination of one of the cold cathode fluorescent tubes 31G and one of the cold cathode fluorescent tubes 31RB that are positioned in close proximity to each other. For example, in the case of a combination of the cold cathode fluorescent tube 31G₁ and the cold cathode fluorescent tube 31RB₁ adjacent thereto, the cold cathode fluorescent tube 31RB₁ is switched on after a lapse of about 0.5 frame time period from the time when the cold cathode fluorescent tube 31G₁ is switched off. Thus, there is no possibility that light from the cold cathode fluorescent tube 31G₁ is mixed into light from the cold cathode florescent tube 31RB₁. This allows further improved color purity to be obtained.

Furthermore, also in the liquid crystal display device 20 according to the present embodiment, it is more preferable that at a latter half of one time frame period, while the cold cathode fluorescent tubes 31RB are switched on, a data signal supplied to each of the data lines DL2, DL5, DL8, . . . that are connected to a group of pixel electrodes 22 among pixel electrodes 22 that corresponds to a green color filter has a potential value as to cause a black display.

In the foregoing description, the cold cathode fluorescent tubes 31G₁ to 31G₉ and the cold cathode fluorescent tubes 31RB₁ to 31RB₉ were set so as to be switched on one by one sequentially at a first half and a latter half of one frame time period, respectively. However, as long as light is not emitted simultaneously by one of the cold cathode fluorescent tubes 31G and one of the cold cathode fluorescent tubes 31RB that are positioned in close proximity to each other, the effect of preventing the occurrence of color mixing can be obtained. From this viewpoint, the following configurations also are possible as modification examples.

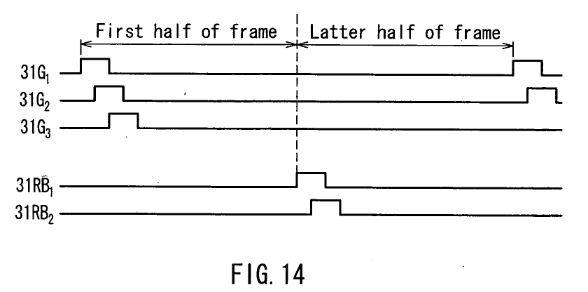

For example, the switch circuits 26a and 26b may be configured so that, as shown in FIG. 13, at a first half of one frame time period, the cold cathode fluorescent tubes 31G₁ to 31G₉ are switched on sequentially in sets of two or more adjacent ones as one set, and at a latter half of one frame time period, the cold cathode fluorescent tubes 31RB₁ to 31RB₉ also are switched on similarly to the above-described manner. Further, the switch circuits 26a and 26b also may be configured so that, as shown in FIG. 14, the cold cathode fluorescent tubes are switched on sequentially so that the respective periods of lighting time thereof overlap.

### Embodiment 3

The following describes an illumination device and a liquid crystal display device provided with the same according to Embodiment 3 of the present invention. In the following description, configurations having functions similar to those of the configurations described in each of the above-described embodiments are denoted by the same reference numerals, and duplicate descriptions of the same are omitted.

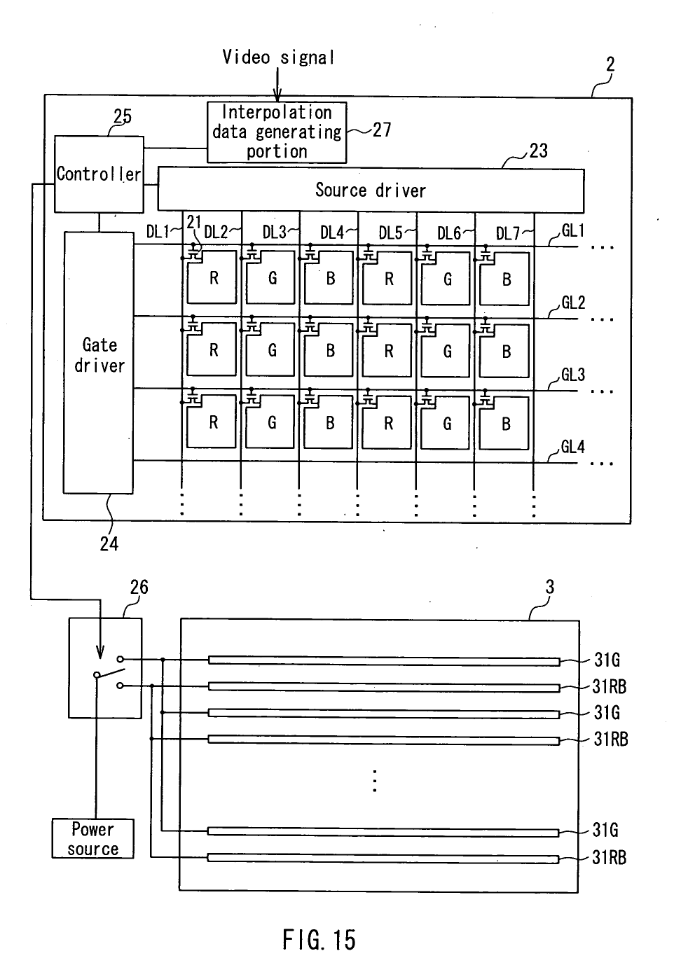

A liquid crystal display device 30 according to the present embodiment is different from Embodiment 1 in that, as shown in FIG. 15, it further includes an interpolation data generating portion 27 that generates a data signal to be supplied to one of data lines DL at a latter half of one frame time period by performing interpolation between a data signal to be supplied to the one of data lines DL in said frame time period and a data signal to be supplied to the one of data lines DL in a frame time period subsequent to said frame time period.

Similarly to the liquid crystal display device 1 according to Embodiment 1, in the liquid crystal display device 30 according to the present embodiment, at a first half of one frame time period, cold cathode fluorescent tubes 31G are switched on, while cold cathode fluorescent tubes 31RB are switched off, and at a latter half thereof, the cold cathode fluorescent tubes 31RB are switched on, while the cold cathode fluorescent tubes 31G are switched off.

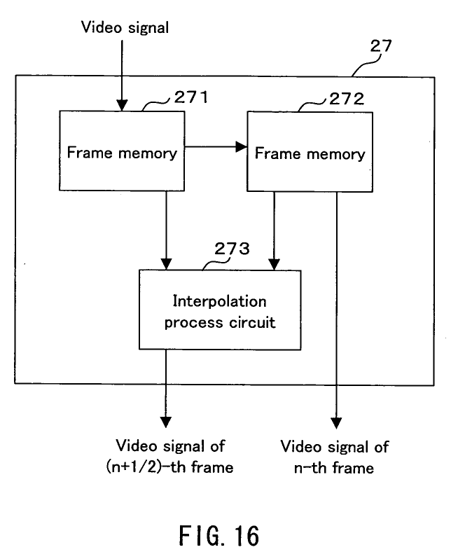

FIG. 16 is a block diagram showing an internal configuration of the interpolation data generating portion 27. As shown in FIG. 16, the interpolation data generating portion 27 includes frame memories 271 and 272 and an interpolation process circuit 273. One frame of a video signal is stored in each of the frame memories 271 and 272.

In the case where a video signal of a n-th frame is stored in the frame memory 271, when a video signal of a succeeding (n+1)-th frame is newly inputted to the interpolation data generating portion 27, the video signal of the n-th frame that has been stored in the frame memory 271 is transferred to the frame 272 to be stored in the frame memory 272. After that, the above-described newly inputted video signal of the (n+1)-th frame is stored in the frame memory 271. Therefore, it follows that two frames of video signals in total are stored in the frame memories 271 and 272.

The interpolation process circuit 273 reads out the video signals of the n-th frame and the (n+1)-th frame from the frame memories 271 and 272 and generates a video signal corresponding to a (n+½)-th frame by an interpolation process. In the interpolation process performed by the interpolation process circuit 273, various well-known interpolation algorithms can be used, though descriptions thereof are omitted herein.

The video signal corresponding to the (n+½) frame generated by the interpolation process circuit 273 and the video signal of the n-th frame stored in the frame memory 272 are supplied to a source driver 23 via a controller 25.

At a first half of the n-th frame, among the video signals of the n-th frame, the source driver 23 supplies a data signal of yellow, a data signal of a green component, and a data signal of cyan to, among the data lines DL, those connected to red pixels, those connected to green pixels, and those connected to blue pixels, respectively. At a latter half of the n-th frame, among the video signals corresponding to the (n+½) frame generated by the interpolation process circuit 273, the source driver 23 supplies data signals of red and blue components to groups of data lines DL among the data lines DL, which are connected to red and blue pixels.

According to the above-described configuration, particularly when moving images are displayed, the occurrence of a color breaking (referred to also as color breakup) phenomenon can be reduced, which is caused due to images of the primary colors being separated in chronological order when displayed.

FIG. 15 shows an exemplary configuration including, similarly to the liquid crystal display device 1 according to Embodiment 1, a switch circuit 26 that, at a first half of one frame time period, switches on the cold cathode fluorescent tubes 31G while switching off the cold cathode fluorescent tubes 31RB, and at a latter half thereof, switches on the cold cathode fluorescent tubes 31RB while switches off the cold cathode fluorescent tubes 31G. However, a configuration also may be adopted in which in place of this switch circuit 26, the switch circuits 26a and 26b of Embodiment 2 described above are provided.

Further, the method of using an interpolation data for suppressing the occurrence of the color breaking phenomenon is not limited to the examples shown in the above-described FIGS. 15 and 16, and the following another specific mode can be considered: the interpolation data generating portion 27 generates interpolation data by performing interpolation between a data signal to be supplied to the one of data lines DL in said frame time period and a data signal to be supplied to the one of data lines DL in a time period one frame prior to said frame time period, and the interpolation data thus generated are supplied to one of the data lines DL at a first half of one frame time period.

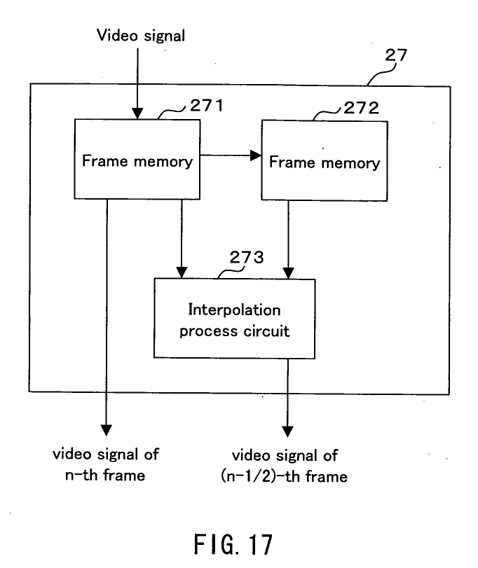

FIG. 17 is a block diagram showing a data signal process in the interpolation data generating portion 27 according to another method using the interpolation data. The specific configuration of the interpolation data generating portion 27, that is, the configuration in two frame memories 271 and 272 each of which stores one frame of a video signal and the interpolation process circuit 273 are provided, is identical to the configuration shown in FIG. 16, except only for the signal process and a signal to be outputted in the interpolation data generating portion 27.

In another method using the interpolation data, in the case where a video signal of a (n−1)-th frame is stored in the frame memory 271, when a video signal of a succeeding n-th frame is newly inputted to the interpolation data generating portion 27, the video signal of the (n−1)-th frame that has been stored in the frame memory 271 is transferred to the frame memory 272 to be stored in the frame memory 272. After that, the above-described newly inputted video signal of the n-th frame is stored in the frame memory 271.

The interpolation process circuit 273 reads out the video signals of the (n−1)-th frame and the n-th frame from the frame memories 271 and 272 and generates a video signal corresponding to a (n−½)-th frame, which is in an intermediate state between a video of the (n−1)-th frame and a video of the n-th frame, by an interpolation process. It should be noted that in the interpolation process by the interpolation process circuit 273, various well-known interpolation algorithms similar to that shown in FIG. 16 can be used.

The video signal corresponding to the (n−½)-th frame generated by the interpolation process circuit 273 and the video signal of the n-th frame stored in the frame memory 271 are supplied to a source driver 23 via a controller 25.

At a first half of the n-th frame, among the video signals corresponding to the (n−½)-th frame generated by the interpolation process circuit 273, the source driver 23 supplies a data signal of yellow, a data signal of a green component, and a data signal of cyan to, among the data lines DL, those connected to red pixels, those connected to green pixels, and those connected to blue pixels, respectively. At a latter half of the n-th frame, among the video signals corresponding to the n-th frame, the source driver 23 supplies data signals of red and blue components to the data lines DL connected to red and blue pixels.

In another method using this interpolation data, a configuration also may be adopted in which in place of the switch circuit 26 in Embodiment 1, the switch circuits 26a and 26b in Embodiment 2 are provided.

The configurations in each of the above-described embodiments as the display devices according to the present invention are merely illustrative, and without limiting the technical scope of the present invention to the above-described specific examples, they can be modified variously.

For example, an example using a cold cathode fluorescent tube as a light source for a backlight is shown above as each of the above-described embodiments, but a hot cathode fluorescent tube may be used in place of the cold cathode fluorescent tube. Further, phosphors presented specifically in the embodiments are no more than illustrative.

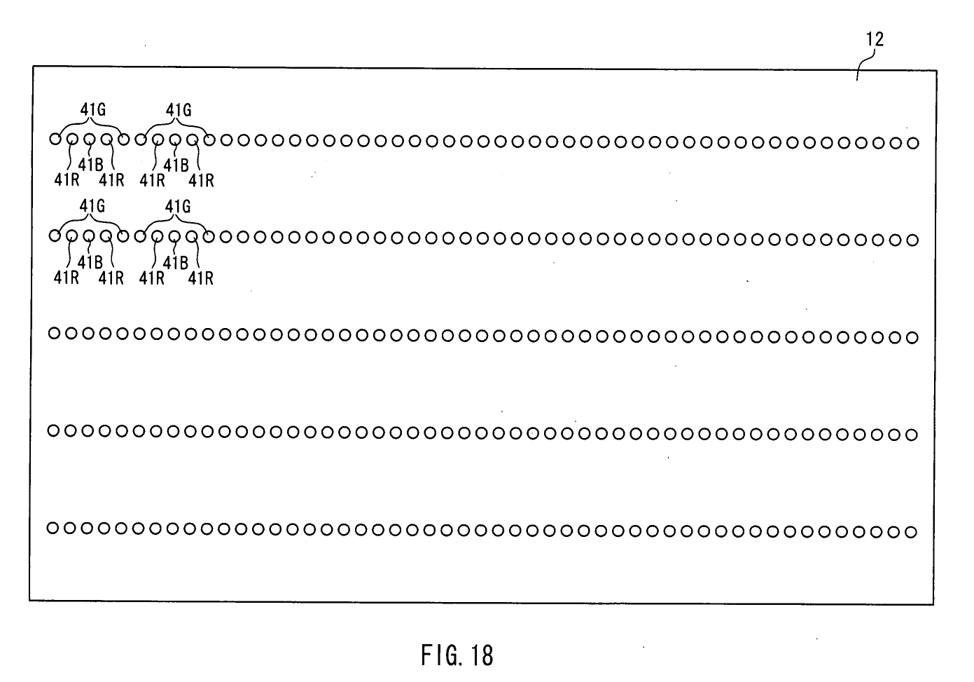

Moreover, other than such fluorescent tubes, it also is possible to use a LED as a light source for the backlight device 3. In that case, a configuration could be adopted in which, in place of the cold cathode fluorescent tubes 31, as shown in FIG. 18, LEDs 41R, 41G, and 41B of the respective colors of RGB are arranged in an orderly manner on a bottom surface of the case 12 of the backlight device 3 (see FIG. 1). This configuration could be such that, at a first half of one frame time period, only the green LEDs 41G are switched on, while the red LEDs 41R and the blue LEDs 41B are switched off, and at a latter half of one frame time period, the red LEDs 41R and the blue LEDs 41B are switched on, while the green LEDs 41G are switched off.

In the case where the LEDs of the respective colors are used as light sources for the backlight device 3 as shown in FIG. 18, it is preferable that, for example, in a liquid crystal display device having a screen size of the 37V type, about 305 LEDs are used in total. In this case, the power consumption of the backlight device 3 would be about 246 W. Although FIG. 18 shows an example with a configuration in which the LEDs 41R, 41G, and 41B of the respective colors of RGB are arranged in an orderly manner in repeated sets of five LEDs composed of LEDs 41G, 41R, 41B, 41R, and 41G, the arrangement and number of the LEDs of the respective colors are not limited only to this example.

Furthermore, in the case of using LEDs in place of the cold cathode fluorescent tubes 31, a configuration may be adopted in which an LED 42 on which light-emitting elements of the respective colors of RGB are mounted as one package is disposed on the bottom surface of the case 12 of the backlight device 3 (see FIG. 1). Also in this LED 42, the light-emitting elements of the respective colors of RGB can be controlled so that the light-emitting elements of one color are switched on/off independently of the light-emitting elements of other colors, and therefore, this configuration could be such that, at a first half of one frame time period, only green light-emitting elements 42G are switched on, while red light-emitting elements 42R and blue light-emitting elements 42B are switched off, and at a latter half of one frame time period, the red light-emitting elements 42R and the blue light-emitting elements 42B are switched on, while the green light-emitting elements 42G are switched off. In the case of using the LED 42 having the above-described configuration as a light source for the backlight device 3, for example, in a liquid crystal display device having a screen size of the 37V type, it is preferable to use about 1,950 LEDs in total. In this case, the power consumption of the backlight device 3 would be about 210 W.

In the case of using LEDs as light sources for a backlight device, instead of the above-described method in which red LEDs and blue LEDs are arranged in addition to green LEDs on a bottom surface of the case of the backlight device so that the red LEDs and the blue LEDs are switched on at a latter half of one frame time period, magenta light-emitting elements may be used that emit light of magenta, which corresponds to a complementary color of green. As an example of such a magenta light-emitting element, the following is known: on a surface of a light-emitting side of a blue LED, a phosphor layer that emits red light when excited by blue is formed so that the element emits light of magenta resulting from synthesis of the light of the blue LED and the light of the red phosphor. The use of such magenta light-emitting elements makes it possible to reduce the kind of LEDs to be used, and accordingly reduces the number of assembly processes because of the reduced number of the kind of components. As a result, cost reduction can be realized.

Moreover, the backlight device 3 is not limited to a direct type backlight as described above and may be an edge-light type backlight in which a light source is disposed on a side surface of a light-guiding body.

Furthermore, although each of the above-described embodiments showed an exemplary configuration including color filters of the three primary colors of RGB, the present invention also can be carried out using a configuration including color filters of three colors of CMY. Further, although in each of the above-described embodiments, at a first half of one frame time period, green, cyan, and yellow pixel portions in one frame were displayed, and at a latter half thereof, red and blue pixel portions were displayed. However, a configuration also may be adopted in which at a first half, red pixels and blue pixel portions in one frame are displayed, and at a latter half, green, cyan, and yellow pixel portions are displayed.

As each of the above-described embodiments, an exemplary configuration is shown, in which, with green being a first color, two kinds of light sources were used as light sources for a backlight device, which are a light source that emits light having a spectrum principally in a wavelength region of green as a first light source; and a light source having spectra principally in wavelength regions of red and blue as a second light source that emits light of magenta, which is a complementary color of green. However, the present invention is not limited to this example: the first color can be blue; and likewise, the first color can be red.

Here, in the image display performed with an ordinary three-band tube or a four-band tube and color filters of three colors of RGB formed on the liquid crystal panel, deterioration in color purity is caused mainly by color mixing of green and blue. Therefore, in order to improve the color purity in a color image display, it becomes essential that a green component and a blue component be separated from each other. Therefore, the following configuration also appears feasible: two kinds of light sources, i.e. a first light source that emits light having a spectrum principally in a wavelength region of blue, and a second light source having spectra principally in wavelength regions of red and green as a light source that emits light of yellow, which is a complementary color of blue, are used as light sources for a backlight device, so that the color purity of the color display is improved. In view of such background, as to the case where the first light source is blue, the second light source is red, and the third light source is green, the details will be described. If blue is used as the first color in the present invention in this way, an image display with five colors composed of three primary colors of RGB+magenta+cyan can be performed.

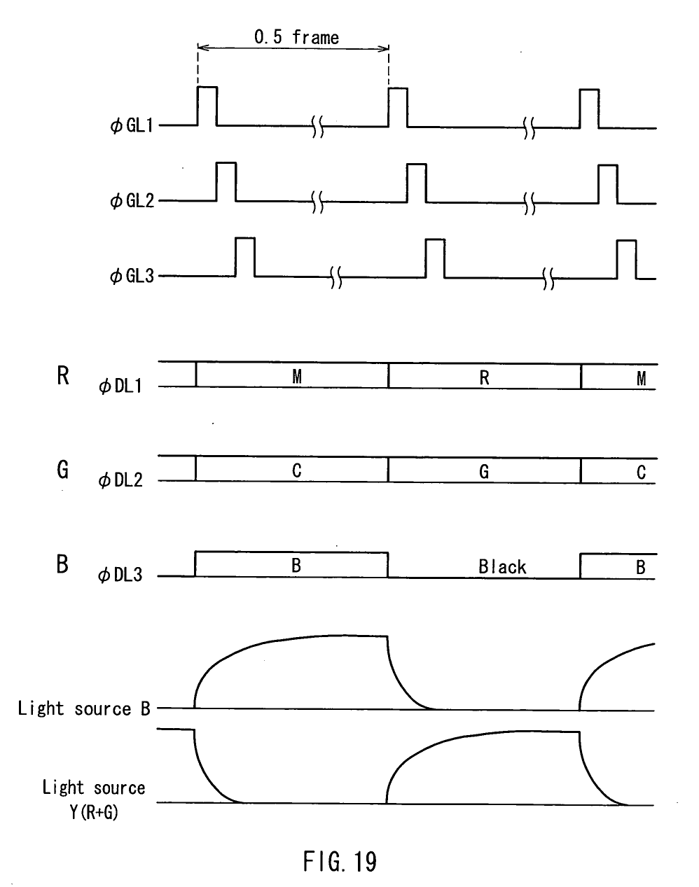

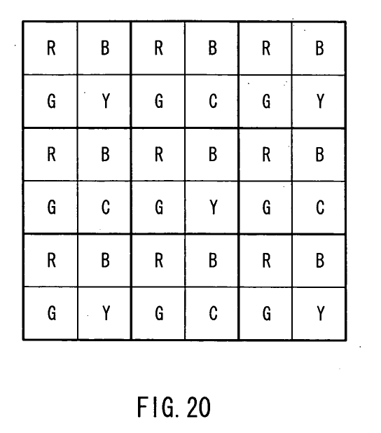

FIG. 19 is a timing chart showing a relationship among timing for switching on/off light sources, timing for supplying a data signal to each of data lines, and amounts of light emitted by the light sources in the case of performing an image display with five colors composed of three primary colors of RGB+magenta+cyan. This figure corresponds to FIG. 3 as for Embodiment 1.

As shown in FIG. 19, a gate pulse having a predetermined voltage is applied sequentially to the scanning lines GL1, GL2, GL3, GL4, . . . of the liquid crystal panel. Here, at a first half of one frame time period, a light source B emitting blue light is switched on while the light source Y(R+G) emitting yellow light, which corresponds to a complementary color of blue, is switched off. Further, at a latter half of one frame time period, the light source B is switched off while the light source Y(R+G) is switched on. In FIG. 19 also, the first and second graphs from the bottom show amounts of light emitted by the light sources of Y(R+G) and B, respectively.

At the first half of one frame time period, a data signal to be applied to blue pixels is supplied to data lines that are connected to a group of pixel electrodes among the pixel electrodes that corresponds to the blue color filter. At the same time, a data signal to be applied to red pixels is supplied to pixel data lines that are connected to a group of pixel electrodes among the pixel electrodes that corresponds to the red color filter. Here, since the filter formed for the pixels is red while light emitted by the light source switched on is blue, the color actually displayed on the pixels is the mixed color of red and blue, which is magenta. Therefore, a data signal to be applied to the red pixel while the blue light source is switched on should be based on a signal for display on magenta pixel. Similarly, with respect to the pixel data lines that are connected to a group of pixel electrodes among of the pixel electrodes that corresponds to the green color filter, a data signal to be applied thereto should be based on a signal for display on the cyan pixels, since the color actually displayed on the pixel is cyan when light emitted by the blue light source is transmitted through the green color filter.

By the operations described above, at a first half of one frame time period, portions constituted of blue pixel portions, magenta pixel portions, and cyan pixel portions in one frame are displayed

At the latter half of one frame time period, a data signal to be applied to red pixels is supplied to data lines that are connected to a group of pixel electrodes among the pixel electrodes that corresponds to the red color filter. At the same time, a data signal to be applied to green pixels is supplied to data lines that are connected to a group of pixel electrodes among of the pixel electrodes that corresponds to the green color filter. Thus, at the latter half of one frame time period, only portions constituted of red pixels and green pixels in one frame are displayed.

At the latter half of one frame time period, while a light source emitting yellow light, which is the mixed color of red and green, is switched on, a data signal to cause a black display is supplied to data lines that are connected to a group of pixel electrodes among the pixel electrodes that corresponds to the blue color filter. Thus, in a similar manner to Embodiment 1, unwanted leakage light from a pixel portion can be blocked.

Further, in the case where a first color is red, a second color is green, and a third color is blue, a first light source emits red light, and a second light source emits cyan light (the mixed color of green and blue), which is a complementary color of red. Then, during the time period in which the first light source emitting red light is switched on, signal data to be displayed on red pixels are applied to data lines that are connected to a group of pixel electrodes among the pixel electrodes that corresponds to the red color filter; signal data to be displayed on yellow pixels are applied to data lines that are connected to a group of pixel electrodes among the pixel electrodes that corresponds to the green color filter; and signal data to be displayed on magenta pixels are applied to data lines that are connected to a group of pixel electrodes among the pixel electrodes that corresponds to the blue color filter. Further, during the time period in which the second light source emitting light of cyan is switched on, signal data to be displayed on green pixels are applied to data lines that are connected to a group of pixel electrodes among the pixel electrodes that corresponds to the green color filter; and signal data to be displayed on blue pixels are applied to data lines that are connected to a group of pixel electrodes among the pixel electrodes that corresponds to the blue color filter. Thus, the image display including five colors composed of three primary colors of RGB+magenta+yellow can be performed.

As described above, by setting blue or red as a first color, the image display including five colors composed of the three primary colors of RGB+magenta+cyan or the three primary colors of RGB+magenta+yellow can be performed, respectively. In either of these cases, similarly to the case of displaying five colors composed of the three primary colors of RGB+cyan+yellow shown in the above-described Embodiment 1, specific effects of the present invention, which allows a display to have higher color purities of the respective colors of cyan, magenta and yellow, can be obtained by the principle described using FIG. 4.

Further, in the case where the first color is blue or red, and LEDs are used as light sources for a backlight device, a configuration may be adopted in which at one of a first half and a latter half of one frame time period, blue light-emitting diodes are caused to emit light, and at the other of the same, red light-emitting diodes and green light-emitting diodes are caused to emit light simultaneously. Alternatively, the configuration may be adopted in which at one of the first half and a latter half of one frame time period, red light-emitting diodes are caused to emit light, and at the other of the same, blue light-emitting diodes and green light-emitting diodes are caused to emit light simultaneously. Furthermore, as the second light source in either of these cases, LEDs emitting yellow light or cyan light can be used

Further, in the case where the first color is blue or red, it is needless to say that this configuration is identical to the above-described Embodiment 1 in the following points: even though the second color and the third color are replaced with each other, there is not much difference in the effects obtained by the respective display devices; a four-color image display can be performed using either one of the second color or the third color; and at a first half and a latter half of one frame time period, a light source to be switched on and display data to be applied to can be replaced with each other.

### INDUSTRIAL APPLICABILITY

The present invention is industrially useful as a display device having high color reproducibility.

1. A display device, comprising:
a display element that includes:
scanning lines and data lines that are arranged in a matrix form;
a switching element that is connected to each of the scanning lines and a corresponding one of the data lines;
a pixel portion that performs a gradation display in accordance with a data signal written from the corresponding one of the data lines when the switching element is brought to an ON state based on a signal of the each of the scanning lines; and
color filters that are arranged so as to correspond to the pixel portions and include three colors composed of a first color, a second color, and a third color that exhibit a white color when mixed;
an illumination device that outputs plane-shaped light to the display element and includes a first light source that emits light of the first color and a second light source that emits light of a color complementary to the first color;
a scanning line driving portion that sequentially supplies a selection signal to each of the scanning lines at a cycle of half a time period in which one frame is displayed in the display element;
a data line driving portion that, at one of a first half and a latter half of the time period in which one frame is displayed in the display element, supplies data signals to the data lines in such a manner that a data signal to be written into a group of pixel portions among the pixel portions that corresponds to the color filter of the first color and a data signal to be written into at least either one of a group of pixel portions among the pixel portions that corresponds to the color filter of the second color and a group of pixel portions among the pixel portions that corresponds to the color filter of the third color is supplied to corresponding one of the data lines, and at an other of the first half and the latter half of the time period, a data signal to be written into the group of pixel portions among the pixel portions that corresponds to the color filter of the second color and the group of pixel portions among the pixel portions that corresponds to the color filter of the third color is supplied to corresponding one of data lines; and
a light source driving portion that, at the one of the first half and the latter half of the time period in which one frame is displayed in the display element, switches on the first light source while switching off the second light source, and at the other of the first half and the latter half of the time period, switches on the second light source while switching off the first light source.

2. The display device according to claim 1, wherein at an other of the first half and the latter half of the time period in which one frame is displayed in the display element, the data line driving portion supplies a data signal for causing each in the group of pixel portions among the pixel portions that corresponds to the color filter of the first color to perform a black display to a corresponding one of the data lines.

3. The display device according to claim 1,
wherein, when, at one of a first half and a latter half of a time period in which one frame is displayed in the display element, a data signal to be written into either one of the group of pixel portions that corresponds to the color filter of the second color and the group of pixel portions that corresponds to the color filter of the third color is supplied to corresponding one of the data lines,
at said one of the first half and the latter half of the time period in which one frame is displayed in the display element, to data lines corresponding to the other one of said groups, which are not supplied with the data signal, among the groups of pixel portions that corresponds to the color filter of the second color or the groups of pixel portions that corresponds to the color filter of the third color, the data line driving portion supplies a data signal for causing a pixel portion to perform a black display.

4. The display device according to claim 1,
wherein in the illumination device, a plurality of the first light sources and a plurality of the second light sources are provided in a direction orthogonal to the scanning lines, and
at one of the first half and the latter half of the time period in which one frame is displayed in the display element, the light source driving portion switches on the plurality of the first light sources successively in an order of arrangement so as to be synchronized with an application of the selection signal to each of the scanning lines, and at an other of the first half and the latter half of the time period in which one frame is displayed in the display element, the light source driving portion switches on the plurality of the second light sources successively in an order of arrangement so as to be synchronized with the application of the selection signal to each of the scanning lines.

5. The display device according to claim 1, further comprising an interpolation data generating portion that generates a data signal to be supplied to one of the data lines at the latter half of the time period in which one frame is displayed in the display element by performing interpolation between a data signal to be supplied to the one of the data lines in said time period and a data signal to be supplied to the one of the data lines in a time period subsequent to said time period.

6. The display device according to claim 1, further comprising an interpolation data generating portion that generates a data signal to be supplied to one of the data lines at the first half of the time period in which one frame is displayed in the display element by performing interpolation between a data signal to be supplied to the one of the data lines in said time period and a data signal to be supplied to the one of the data lines in a time period one frame prior to said time period.

7. The display device according to claim 1,
wherein the light of the first color has a spectrum principally in a wavelength region of green,
the light of the second color has a spectrum principally in a wavelength region of red, and
the light of the third color has a spectrum principally in a wavelength region of blue.

8. The display device according to claim 1,
wherein the light of the first color has a spectrum principally in a wavelength region of blue,
the light of the second color has a spectrum principally in a wavelength region of red, and
the light of the third color has a spectrum principally in a wavelength region of green.

9. The display device according to claim 1, wherein each of the first light source and the second light source is a cold cathode fluorescent tube or a hot cathode fluorescent tube.

10. The display device according to claim 9, wherein in the illumination device, a plurality of the first light sources and a plurality of the second light sources are provided and arranged so as to alternate with each other one by one or in sets of a plural number of the first or second light sources.

11. The display device according to claim 1,
wherein the first light source is a green light-emitting diode, and
the second light source is formed of a combination of a red light-emitting diode and a blue light-emitting diode that emits light at a same time that the red light-emitting diode emits light.

12. The display device according to claims 1,
wherein the first light source is a blue light-emitting diode, and
the second light source is formed of a combination of a red light-emitting diode and a green light-emitting diode that emits light at a same time that the red light-emitting diode emits light.

13. The display device according to claims 1,
wherein the first light source is a green light-emitting diode, and
the second light source is formed of a combination of a blue light-emitting diode and a magenta light-emitting element that is formed of a phosphor that emits red light when excited by blue light of the blue light-emitting diode.
